(19) United States
(12) Patent Application Publication
(10) Pub. No.: US 2012/0169872 A1
(43) Pub. Date: Jul. 5, 2012

(54) METHOD AND SYSTEM FOR DETECTING DURESS

(75) Inventor: Jon L. Williamson, Newburyport, MA (US)

(73) Assignee: SCHNEIDER ELECTRIC BUILDINGS AB, MALMO (SE)

(21) Appl. No.: 12/983,028

(22) Filed: Dec. 31, 2010

(51) Int. Cl. H04N 7/18

(52) U.S. Cl. 348/143; 348/E07.085

(57) ABSTRACT

The system and method is an analysis video to determine if a person is displaying a pre-determined position indicating that he/she is being held or forced to act under duress. The system takes a digital video image and compares the image to a library of video duress patterns. If a duress pattern is recognized, then the system notifies another party of the situation, such as a security officer.

### FIELD OF THE INVENTION

The present invention relates to physical security and access control and more particularly to detecting if a person is under duress.

### BACKGROUND OF THE INVENTION

If a person is in a situation in which they are in duress from a third party intruder such as a robbery, the methods of notifying others are limited. Some of the current conventional methods include a duress pin, reverse card, duress biometric, and panic button.

In the duress PIN method, to enter a secured area the operator enters a special PIN which silently signals a duress condition, but still permits access to the secured area. In the reverse card method, to enter a secured area the operator swipes his magnetic stripe card in the opposite direction which silently signals a duress condition, but still permits access to the secured area. In the duress biometric method, to enter a secured area the operator uses the opposite hand, finger, or eye which silently signals a duress condition, but still permits access to the secured area. In the panic button method, a panic button is placed either in a fixed or mobile location to which the person experiencing the duress has access. Unlike the three previous methods, the panic button method does not have to be associated with a door.

Unfortunately the first three of these methods are tied to a specific access technology, that of PIN, magnetic strip card, and biometrics. In addition, none of these are the most common technology used for access control, which is proximity and smart cards. Furthermore, these (proximity and smart card) common technologies are currently limited in duress applications. The fourth method, that of the panic button requires a dedicated device. In addition, all of these duress methods are commonly applied throughout the world, so they are know to criminals who may prevent the operator from performing such actions.

### SUMMARY OF THE INVENTION

It has been recognized that while locations have video systems, these video systems are not monitored full time or in real time. It is recognized that many environments the video is not reviewed until after it is known that an event has occurred such as a robbery. The system and method of determining duress of the instant invention analyzes video to determine if a person is displaying a pre-determined position indicating that he/she is being held or forced to act under duress. The system takes a digital video image and compares the image to a library of video duress patterns. If a duress pattern is recognized, then the system notifies another party of the situation, such as a security officer.

In an embodiment, the duress detection system for assessing if a person is in duress includes at least one video camera providing a live video feed. A library contains at least one representation of duress occurring. The system has a mechanism for comparing the live video feed from the video camera to the at least one representation of duress occurring. A mechanism, a comparison unit, determines if the live video feed has an image sufficiently similar to the image of the at least one representation of duress occurring. A notification mechanism notifies that the system has noted a person showing patterns of duress.

In an embodiment, the representation in the library includes a representation of a position of a person. In an embodiment, the notification mechanism sends an alarm. In an embodiment, the notification mechanism sends a live video feed of the video camera wherein the mechanism for determining duress has determined duress is being shown.

In an embodiment, the representation in the library includes a representation of the position of an object.

In an embodiment, the live video feed is of a digitized image.

In a method of the invention, video images are captured in real time from at least one camera. The live video feed from the video camera is compared to the images of representations of duress occurring stored in a library. The method determines if the live video feed has an image sufficiently similar to at least one of the images of representation of duress occurring. A third party is notified that the system has noted a pattern of a representation of duress occurring.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a pictorial display of a convenience store using the duress system according to the invention;

FIG. 2 is a schematic of a system for detecting duress according to the invention;

FIG. 3 is a schematic of a method of determining if a duress signal has been given and notification issued; and

FIG. 4 shows a pictorial display of an entrance to an office complex.

### PREFERRED EMBODIMENTS OF THE INVENTION

The system and method is an analysis video to determine if a person is displaying a pre-determined position indicating that he/she is being held or forced to act under duress. The system takes a digital video image or images and compares the image to a library of video duress patterns. If a duress pattern is recognized, then the system notifies another party of the situation, such as a security officer.

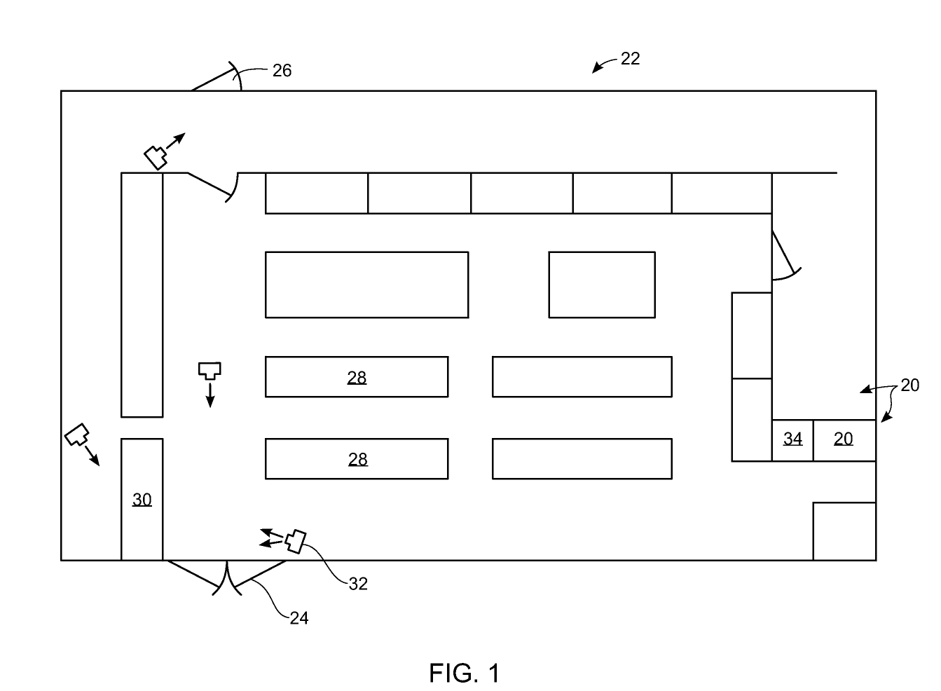

Referring to FIG. 1, a pictorial display of a convenience store 22 using the duress detection system 20 is shown. In this simplistic representation, the convenience store 22 is shown having a front entrance 24 and a back entrance 26. In addition, the store 22 has a plurality of shelves 28 and a front counter 30. The system 20 has a plurality of video cameras 32 positioned to view certain locations in the store 22 including the front counter 30.

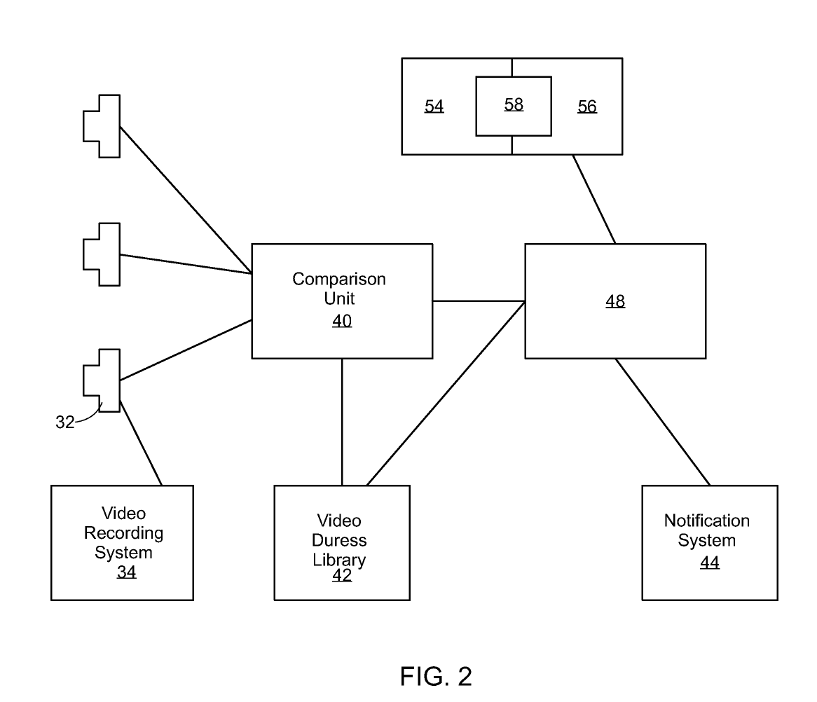

The convenience store 22 has a video recording system 34 that records/stores the images from the video camera 32 for future viewing. The storage of the images can be in various forms including tape, disk, and memory. In addition, the duress detection system 20 has various components as described below with respect to FIG. 2.

Referring to FIG. 2, a schematic of the duress detection system 20 for detecting duress is shown. The duress detection system 20 has a plurality of video cameras 32 that send a signal to a comparison unit 40. The comparison unit 40 compares the live video with stored patterns in a video library 42.

The duress detection system 20 has a controller or central processing unit 48 for controlling the duress detection system 20. The CPU 48 in addition to communicating with the comparison unit 40 accesses the video duress library 42 that contains information related to specific patterns to which the video received from the video cameras 32 is compared to determine if an individual is being held under duress.

The duress detection system 20 also has a notification system 44 that notifies a third party if the duress detection system 20 determines that there is duress. As indicated below, the notification can take various forms.

Still referring to FIG. 2, the duress detection system 20 includes an interface device 54 for receiving operator input and a graphical display system 56 for an operator to control the security system 20. In another embodiment, the interface device 54 is a keyboard and a point of control such as a mouse or tracker ball. In another embodiment, the interface device 54 and the graphical display system 56 are incorporated into one device such as a touchscreen 58. In addition, the duress detection system 20 can receive other inputs such as through the notification system 44 or updates in the forms of disk or memory uploads to the video duress library 42.

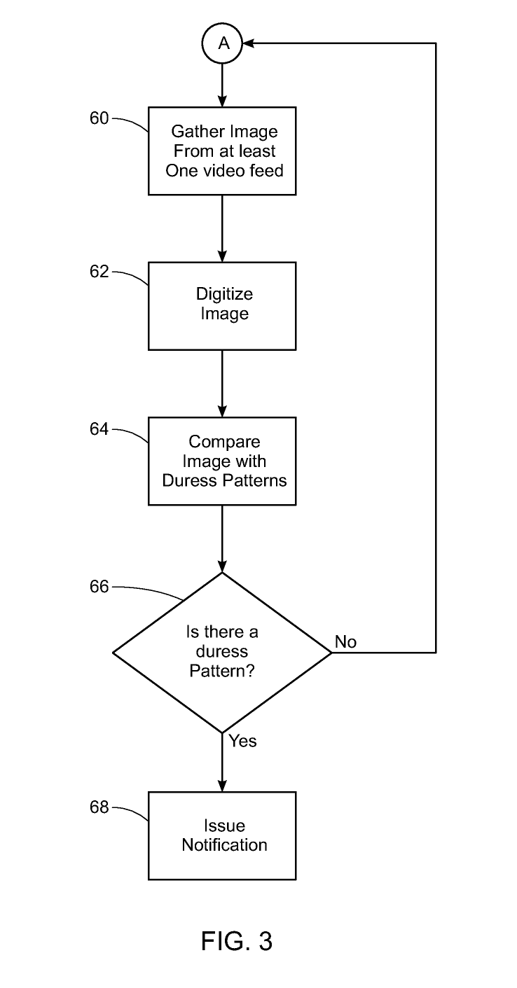

Referring to FIG. 3, a schematic of a method of determining if a duress signal has been given and notification issued is shown. The duress detection system 20 gathers images from at least one video feed such as video cameras 32 as represented by block 60. The image is placed in a digital form which is typically done nowadays by the video cameras 32 as represented by block 62.

The security system 20 compares the digital images with duress patterns retained in the video duress library 42 as represented by block 64. The comparison unit 40 determines if there is a duress pattern shown as represented by decision diamond 66. If no distress pattern is shown as represented by the “no” branch, then the process continues gathering and comparing images in real time. If a distress pattern is noted as represented by the “yes” branch, then a notification is issued by the notification system 44 of the duress detection system 20 as represented by block 68.

While stated as comparing images to image, it is recognized by one skilled in the art that cameras and computer vision use mathematical algorithms and convert points in the image, such as a human face or the position of arms and hands, to geometrical relationships. The system is capable of proportionally adjusting the relationship to recognize objects and/or arrangements (position) even if the object and/or arrangement is located in different positions in the image of the camera or distance from the camera.

The duress patterns that will cause notification can be designated by the operator of the system 20. The patterns can be selected from a catalog in the video duress library 42. In addition or in the alternative, the operator can with the assistance of the system 20 add specific duress patterns such as a box of tissue discussed below.

In the convenience store 22, example shown in FIG. 1, the feeds from the video cameras 32 typically would not be sent to persons to monitor in real time, but rather placed on video tape or other recording media for review in the future as represented by the video recording system 34. However, when the duress detection system 20 detects a distress signal, the notification system 44 of the duress detection system 20 could send notification to various sources, including a central monitoring section, local police, and/or a security service. The notification could be an alarm and/or live video feeds of the particular camera 32 and other relevant information.

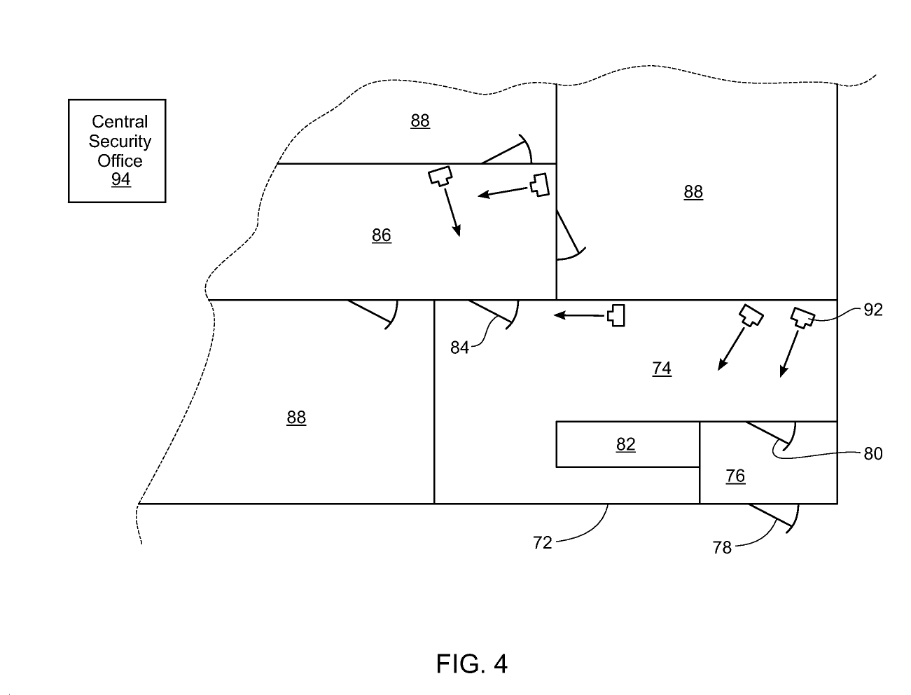

Referring to FIG. 4, a pictorial display of an entrance to an office complex 72 is shown. The portion of the office complex 72 shown has a lobby 74 which is accessed via a vestibule 76 through a pair of doors 78 and 80. In the lobby 74, there is a desk 82 for a receptionist and a door 84 to a hallway 86 in the building. The hallway 86 leads to a plurality of offices 88. The office complex 72 has a plurality of video cameras 92 wherein the feeds are sent to a central security office 94 shown broken out from the rest of the building.

In a large office complex 72, the central security office 94 may have hundreds of video feeds that it may view. In contrast to the convenience store 22, shown in FIG. 1, where putting your hands up may be a proper distress signal in that a criminal would be under the assumption that no one would be monitoring the video feed, such a distress signal would not be appropriate for an office complex 72. In this situation, another unique signal which does not typically occur such as covering their face with their hand would be appropriate.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

In addition to gestures by people, it is recognized that movement of objects or positioning of objects could be a signal of duress. For example, the moving of a box of tissues from one point on the desk to another point on the desk could be a signal. Likewise, the flipping of an object over on the desk could be a signal.

In addition, it is recognized that the actions by the third party that is causing the duress could be the signal of duress. For example, the duress detection system 20 could recognize patterns such as someone holding up a gun. In addition, the movement of an object, such as backpack, over a counter at a bank, could be a signal.

It is recognized that in most situations, an operator would prefer to err on the side of having more false positive notification in contrast to missing actual duress situations.

Furthermore, the duress detection system 20 could learn to recognize faces of persons that are allowed in a certain location and notify if someone that should not be in the location is in the location. For example, in the convenience store 22 if the staff consists of nine employees that are allowed behind the counter, if the system 20 sees a face which it does not recognize the system 20 could notify a third party such in a security office.

It is recognized that while FIG. 1 shows the video typically stored on site, it may be typical to store video remotely in a “cloud” facility.

What is claimed:

1. A duress detection system for assessing if a person is in duress, the system comprising:
at least one video camera providing a live video feed;
a library containing at least one representation of duress occurring;
a mechanism for comparing the live video feed from the video camera to the at least one representation of duress occurring;
a mechanism for determining if the live video feed has an image sufficiently close to the image of the at least one representation of duress occurring; and
a notification mechanism for notifying that the system has noted a person showing patterns of duress.

2. A duress detection system of claim 1 wherein the representation in the library includes a representation of a position of a person.

3. A duress detection system of claim 2 wherein the notification mechanism sends an alarm.

4. A duress detection system of claim 2 wherein the notification mechanism sends a live video feed of the video camera wherein the mechanism for determining duress has determined duress is being shown.

5. A duress detection system of claim 1 wherein the representation in the library includes a representation of a position of an object.

6. A duress detection system of claim 5 wherein the notification mechanism sends an alarm.

7. A duress detection system of claim 5 wherein the notification mechanism sends a live video feed of the video camera wherein the mechanism for determining duress has determined duress is being shown.

8. A duress detection system of claim 1 wherein the live video feed is of a digitized image.

9. A method of detecting duress comprising:
capturing video images in real time from at least one camera;
comparing the live video feed from the video camera to the images of representation of duress occurring stored in a library;
determining if the live video feed has an image sufficiently close to at least one of the images of representation of duress occurring; and
notifying a third party that the system has noted a pattern of representation of duress occurring.

10. A method of detecting duress of claim 9 wherein the representation in the library includes a representation of a position of a person.

11. A duress detection method of claim 10 wherein the notification mechanism sends an alarm.

12. A duress detection method of claim 10 wherein the notification mechanism sends a live video feed of the video camera wherein the mechanism for determining duress has determined duress is being shown.

13. A method of detecting duress of claim 9 wherein the representation in the library includes a representation of a position of an object.

14. A duress detection method of claim 9 wherein the live video feed is of a digitized image.
